(19) United States
(12) Patent Application Publication
(10) Pub. No.: US 2017/0294245 A1
(43) Pub. Date: Oct. 12, 2017

(54) METHOD FOR ERECTING A STRUCTURE FROM BUILDING BLOCKS AND/OR SLABS

(71) Applicant: EKSORB LTD, Ekaterinburg (RU)

(72) Inventor: Victor Pavlovich REMEZ, Ekaterinburg (RU)

(21) Appl. No.: 15/511,219

(22) PCT Filed: Apr. 14, 2015
(86) PCT No.: PCT/RU2015/000243

§ 371 Date: Mar. 14, 2017

(30) Foreign Application Priority Data
Sep. 15, 2014 (RU) 2014137187
Sep. 15, 2014 (RU) 2014137189

(51) Int. Cl. G21F 9/12; E04C 1/40; E04B 1/04; E04H 5/02

(52) U.S. Cl. CPC G21F 9/12; E04H 5/02; E04C 1/40; E04B 1/04; G21Y 2002/50

(57) ABSTRACT

The group of inventions relates to constructing structures, such as the buildings of nuclear power plants, which are erected from monolithic blocks or slabs made of concrete or reinforced concrete. A block or a slab contains a built-in container with components for the sorption extraction, from water, of radionuclides or toxic substances. The container has elements for feeding-in contaminated water and for evacuating treated water. An erection method includes building a structure using the said blocks or slabs. A method for manufacturing a building block or slab includes forming a body out of concrete, embedding into same at least one container having water-treatment components, and having fittings or flanges for feeding-in contaminated water and for evacuating treated water. The invention provides for safe operations when erecting structures, and prevents the spread of radionuclides beyond the boundaries of a structure.

The proposed group of inventions is related to the construction field, namely, to the construction of assembled or monolithic erected or reconstructed structures such as NPP (Nuclear Power Plant), aboveground or underwater foundations of such structures, support walls, burial sites for concentrated toxic materials and radioactive waste, constructed using monolithic concrete blocks and/or slabs, and for the production of blocks or slabs for this purpose manufactured on-site or at factories.

The closest of known similar products is a structure, produced by using blocks installed into permanent positions. These blocks are designed as concrete tanks with containers within them. These containers are filled with radioactive waste prior to placing these containers into the structure. Furthermore, the space between block walls and container walls is also filled with radioactive waste with adhesive, but with a lesser concentration than within containers. The block tank is closed on top with a connected removable lid (U.S. Pat. No. 5,545,796, 1996).

There is a known manufacturing method to produce block-shaped construction materials, which contains a tank, which, in turn, consists of a container filled with radioactive waste. Furthermore, the space between container walls and tank walls is filled with granular material (patent DE JY^{◯} 4302536, 1994).

The closest manufacturing method of construction blocks in the shape of concrete tanks, which would house containers filled with radioactive waste or toxic materials. Furthermore, the space between block and container walls is also filled with radioactive waste with adhesive, but with a lesser concentration than within containers. The block tank is closed on top with a connected removable lid (U.S. Pat. No. 5,545,796, 1996).

Deficiencies of these known construction structures manufacturing methods from its building blocks and/or slabs is a requirement to handle radioactive materials to place containers with them into blocks and perform transportation of these blocks with radioactive materials, which negatively impacts work safety and requires additional labor cost for this task and personal protection for employees, performing this task.

Deficiencies of known designs are the ability to use them only to bury previously collected radioactive materials in those containers. Furthermore, it is necessary to re-load radioactive materials to fill containers. To potentially use a block as a construction structure component, e.g. foundation or support wall, it is necessary to place it into a design position, which reduces job safety. An inability of solving the stated technical specification by known solutions is because they are created after emergency situations occur and require difficult tasks and creation of additional space and time to fight it.

Furthermore, a deficiency of known constructions is an inability to use them as building materials, since their durability depends on the properties of radioactive elements, placed within them.

The task of these inventions is to ensure safety for jobs performed to manufacture blocks and/or slabs and erect structures using them, as well as to prevent a proliferation of radionuclides in liquid medium beyond the borders of the erected structure during emergency situations within it or within close proximity of it, due to an expansion of functional possibilities of building blocks used in it, since an erection of the construction structure with previously (during its construction) placed within it or in its elements, for sorptive extraction from pooled water in it and/or in close proximity to it, with toxic elements and/or radionuclides, preferably cesium, which does not require hazardous movement of individual tanks, containing radionuclides, for their further placement within a protective container for burial.

The relevance of the solved task is confirmed by research conducted from 2004 to 2007 by five research expeditions to determine Cs concentration in water of the water column at the Rokkaso Village, Aomori, Japan, where the nuclear fuel regeneration plant, Japan Nuclear Fuel Ltd, underwent an experimental operation in March 2006. Large volume salt water samples were taken at the place of filter and concentration systems at various depths of water. In the researched area, Cs¹³⁷ was not found on solid particles. Dissolved Cs¹³⁷ demonstrated a temporary dynamic, especially in surface waters. Based on these results, it was concluded that the researched area did not have any significant Cs¹³⁷ contamination. Cs¹³⁷ concentration varies, influenced by the mixture of Tsugaro and Oyashio currents. Cs¹³⁷ distribution dynamic was determined by time and space in discharge waters of the nuclear fuel processing plant in Rokkaso Village, Aomori, Japan//Takahiro Nakanishi, J Radioanal Nucl Chem (2010) 283:831-838.

The stated task is achieved by the following:
The method of constructing a structure out of building blocks and/or slabs, preferably made of concrete, having elements, preferably pipes, junction pipes or flanges to inlet water, containing radionuclides, preferably cesium and/or toxic materials, and outlet for treated water, placed in accordance with accepted design for erecting structures, with volume, at least, to correspond to one or more of them, introducing, during production, a container with components for sorptive extraction of radionuclides, preferably cesium and/or toxic materials, out of water. Furthermore, monolithic blocks or slabs may be used to manufacture containers, after there is no more sorbents to extract radionuclides, preferably cesium or toxic materials, from water. Blocks or slabs get monolithic by introducing hardening or self-hardening components. Also, at least a part of blocks and/or slabs may be placed with a possible contact with, at least, one of the surfaces of water, subjected to treatment from radionuclides. Furthermore, after consuming all sorbents that existed in the container, the contents get monolithic, while a block or a slab is left in the design position in the structure. Furthermore, the structure may be designed with a placement of blocks and/or slabs as a foundation, walls, cover, supporting wall, restricting potentially hazardous materials placed inside or outside the erected structure. While placing several containers within a block or a slab, they can be connected with each other in parallel and/or in series;
The method of manufacturing building blocks or slabs is performed by concrete or reinforced concrete molding, preferably multi-layer, where at least one encased container with components for sorptive extraction of toxic materials and/or radionuclides, preferably cesium, from water, and using junction pipes or flanges to inlet water, containing toxic materials and/or radionuclides, preferably cesium, and discharging treated water. Furthermore, while molding blocks and/or slabs, a tank may be placed within them, containing a product to solidify used up sorbents, which are used for sorptive extraction of radionuclides or toxic materials from water. Sulfur concrete or polymer concrete may be used instead of concrete. Furthermore, sulfur concrete or polymer concrete may be used as one of the layers.

The structure is made of building blocks and/or slabs, with at least one of them containing an encased in its concrete or reinforced concrete body, at least one container with sorbents to extract radionuclides, preferably cesium or toxic materials, from water, and having a component, preferably a pipe, junction pipe or flanges to inlet water, containing radionuclides, preferably cesium, and to discharge treated water. Furthermore, the structure may be placed in water, subject to its treatment from radionuclides, contacting with at least one of its surfaces. The structure can be designed as a foundation or support wall. The structure may be placed at the partition between water subjected to treatment from radionuclides and treated water. The structure can be designed as a cascade of water tanks connected in parallel and/or in series, with different degrees of purity. The structure can be equipped with encased containers with sorbents to extract radionuclides or toxic materials from water, connected to, preferably, to each abovementioned container;
A building block is preferably designed as a multi-layer concrete or reinforced concrete body with at least one encased container with a junction pipe or flanges to inlet and discharge water, containing toxic materials and/or radionuclides, preferably cesium, with sorbents to extract toxic materials and/or radionuclides, preferably cesium, from water. Containers within a block (at least two) may be connected to each other in series or in parallel. A building block may have an element to shut off junction pipe or flanges channels either mechanically or by supplying self-hardening products from a tank with such product within it. Sulfur concrete or polymer concrete may be used instead of concrete or as one of the layers. A mechanical shutoff of junction pipes or flanges and/or supplying a self-hardening product can be controlled remotely.
A building slab, monolithic or factory-made, designed as a multi-layer concrete or reinforced concrete body, with at least one encased container with at least one encased container with a junction pipe or flanges to inlet and discharge water, containing toxic materials and/or radionuclides, preferably cesium, with sorbents to extract toxic materials and/or radionuclides, preferably cesium, from water. Containers within a slab are connected to each other in series or in parallel. A building slab may have an element to shut off junction pipe or flanges channels either mechanically or by supplying self-hardening products from a tank with such product within it, preferably by remote control.

The term “monolithic” means a product, manufactured directly in the design position at the constructed structure.

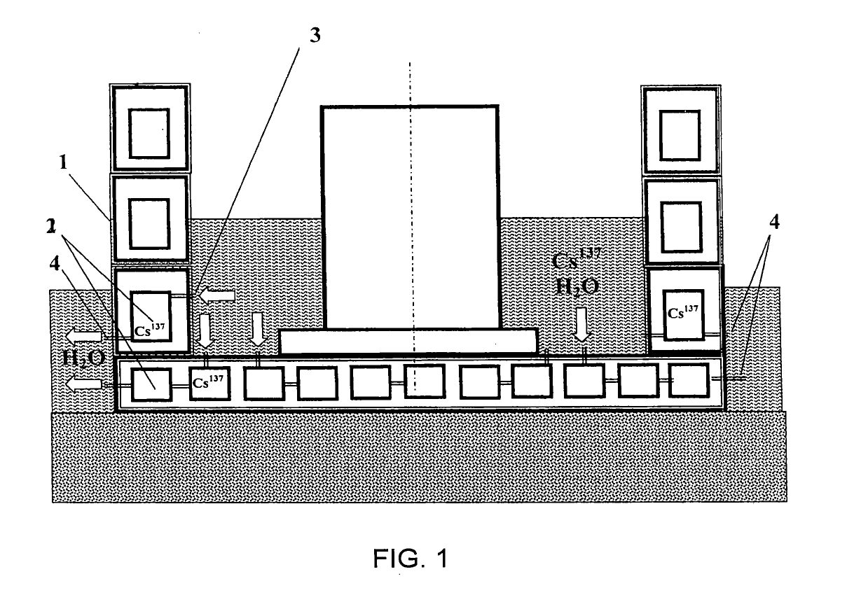

FIG. 1 shows a schematic structure from blocks and slabs, made by a previously described method without tanks with radionuclides and sorbents.

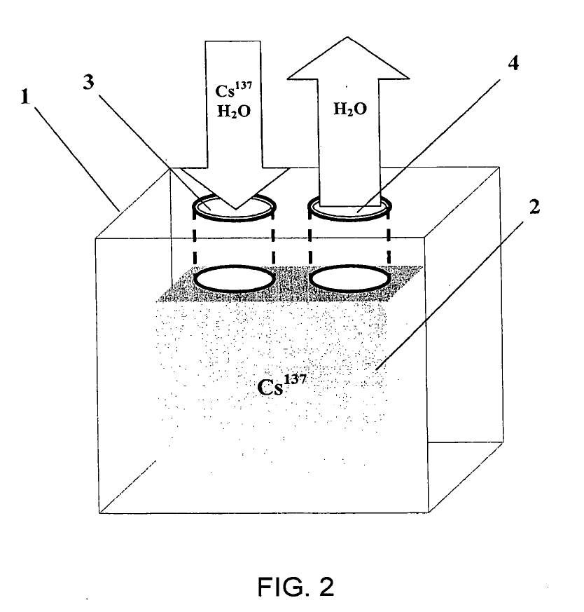

FIG. 2 shows one of examples of manufacturing a monolithic block with a container placed in it, containing sorbents for the consequent extraction of radionuclides, preferably cesium or toxic materials, from water. Arrows show the movement direction of a liquid, containing radionuclides and treated water, through a block.

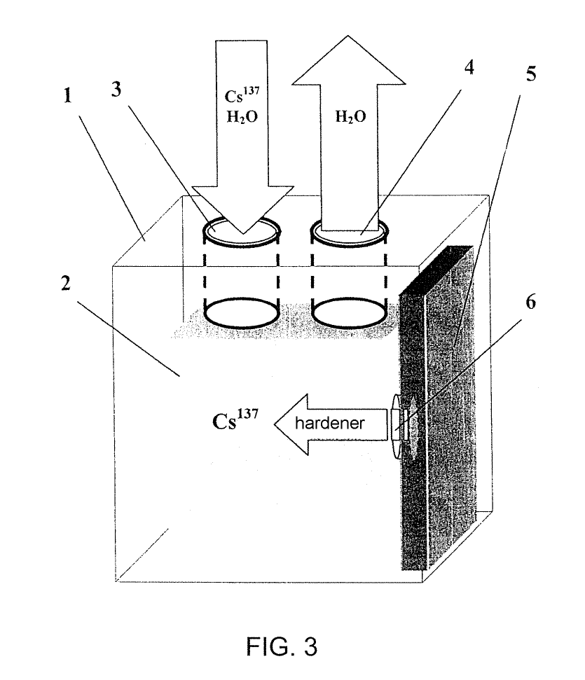

FIG. 3 shows an example of the implementation of the proposed technical solution as a monolithic block corresponding to FIG. 2, but with a tank, placed inside the block, to harden medium, containing radionuclides or toxic materials, within the block container.

A building block or a slab is designed, preferably, as a multi-layered concrete (concrete mixture) or reinforced concrete body. A block or a slab is manufactured in accordance with all process requirements applicable to high quality reinforced concrete products (reinforced carcass, additives to cement mixture, increasing moisture resistance, density and durability of concrete). The purpose of the concrete block or slab is a maximum protection of at least one container (filter with selective sorbent), placed within it, containing sorbents to extract toxic materials and/or radionuclides, preferably cesium, from filtered water. The block or slab must be well protected from any external impacts. To a certain degree, they must absorb radioactive isotope emissions, concentrated in the container (filter) and correspond to design requirements when building special sites (radioactive waste or toxic material storage units). At least one container 2, equipped with junction pipes and flanges to supply water 3, containing toxic materials and/or radionuclides, preferably cesium, and to discharge treated water 4, is encased within the manufactured block. Sorbents to extract toxic materials and/or radionuclides, preferably cesium, from water, are placed within the container 2 prior to or after its placement within the block. A building block or a slab may have a system (not shown in drawings) to mechanically shut off channels of junction pipes or flanges by supplying a self-hardening material preferably from a tank containing this material. Sulfur concrete or polymer concrete may be used as a concrete for the building block, or as one of its layers in accordance with abovementioned requirements. The mechanical shutoff of junction pipes or flanges and/or supplying a self-hardener may be remotely controlled (not shown on drawings). A block or a slab may be equipped with a self-hardener, preferably supplied from tank 5, connected by the supplying pipe 6 or from another block or slab tank in a nearby proximity.

When building a structure out of building blocks and/or slabs, at least one or one of them contains one encased abovementioned container 2 in its concrete or reinforced concrete body, containing sorbents to extract radionuclides, preferably cesium, or toxic materials, from water. The structure, to reinforce its technical result, may be designed as a cascade, with tanks connected to each other in parallel and/or in series, containing water with various degrees of purification. Furthermore, the structure may be placed within water subjected to treatment from radionuclides, e.g. in a connected cesspool or natural body of water, which would require treatment of water from radionuclides. In that case, the structure contacts at least one of the structure surfaces. Depending on the accepted design, the structure may be designed as a foundation or support wall. The structure may be placed between water, undergoing treatment, and treated water. The structure may be equipped, within it or without, a system to encase used containers with sorbents to extract radionuclides or toxic materials from water, preferably connected to each mentioned container.

An example of technical solution implementation.

A cylindrical container (filter), 0.70 m high, 0.30 m in diameter, containing 50 kg of selective sorbent based on Berlin blue (modified iron ferro-cyanide) was placed into the center of the concrete cube during its production (1.7 m rib). Using container (filter) junction pipes, 200 m³ of natural water (fresh or mixed with sea water) was supplied, which was previously used to decontaminate structures located in a radioactive contamination zone. The content of the radionuclide Cs¹³⁷ (cesium-137) in treated water was approximately 10,000 Bq/L, while water contamination, after filtering, did not exceed 5 Bq/L (according to current sanitary regulations, it is possible to discharge into environment without any restrictions).

After a completion of supplying treatable water, the container (filter) and channels within the concrete block, which were used to supply water into filter, were filled with a self-hardening adhesive to encase the sorbent and to make the container (filter) airtight.

The measurements have shown that gamma radiation dosage on all concrete cube surfaces (containing filter container with used sorbent) does not exceed the gamma ray background of environment (less than 0.5 rem/year), which means that this product is suitable to use as a building component.

What is claimed:

1. A method of constructing a structure from building blocks and/or slabs, preferably made of concrete, blocks and/or slabs equipped with such components as pipes, junction pipes or flanges to supply water, containing radionuclides, preferably cesium and/or toxic materials, and to discharge treated water, encased or installed in accordance with the accepted design of the structure, while one or one of them shall have a container, placed within the block during the production, containing sorbents to extract radionuclides, preferably cesium or toxic materials, from water.

2. A method per item 1, differing by having a block and/or slab, with encased container in them during production, with used up sorbents to extract radionuclides, preferably cesium and/or toxic materials, from water, are further encased by introducing hardeners and self-hardeners.

3. A method per item 1, differing by having at least a part of blocks and/or slabs placed with a possibility to contact at least one of the surfaces, subjected to treatment of water from radionuclides, and when all sorbents are used up, the contents of that container are encased, and the block or slab are placed in a design position within the structure.

4. A method per any of items 1-3, differing by having the structure designed with blocks and/or slabs as a foundation, walls, covers, support wall, restricting a potentially hazardous object, placed inside or outside of the erected structure.

5. A method per item 1, differing by having several containers within the block or slab connected to each other in parallel and/or in series.

6. A structure made of building blocks and/or slabs, where at least one or one of them contains at least one container with sorbents for extracting radionuclides, preferably cesium or toxic materials, from water, and equipped with, preferably, pipes, junction pipes or flanges to supply radionuclides, preferably cesium, water and to discharge treated water, encased in the structure's concrete or reinforced concrete body.

7. A structure per item 6, differing by having it placed in water, subject to being treated from radionuclides, contacting, at least, with one of its surfaces.

8. A structure per item 6 or 7, differing by having it designed as a foundation or a support wall.

9. A structure per item 8, differing by having it placed between water, undergoing treatment from radionuclides and treated water.

10. A structure per item 6, differing by using several containers designed as a cascade, connected to each other in parallel and/or in series and to water tanks with various degrees of treatment.

11. A building block structure per item 6, differing by having sorbents to extract radionuclides or toxic materials from water encased in containers, used for that purpose, connected, preferably, with each mentioned container.

12. A method of producing building blocks or slabs by molding, preferably as a multi-layered concrete or reinforced concrete body, with at least one encased container with sorbents to extract toxic materials and/or radionuclides, preferably cesium, from water, equipped with junction pipes or flanges to supply water, containing toxic materials and/or nuclides, preferably cesium, and to discharge treated water.

13. A method per item 12, differing by having a tank with used up sorbents to extract radionuclides or toxic materials from water, encased when molding a block and/or a slab.

14. A method per item 12, differing by having sulfur concrete or polymer concrete used for a whole body or one of the layers.

15. A building block or slab, monolithic or factory made, preferably designed as a concrete or reinforced concrete multi-layer body with encased, at least, one junction pipe or flanges to supply and discharge water, containing toxic materials and/or radionuclides, preferably cesium, container with sorbents to extract toxic materials and/or radionuclides, preferably cesium, from water.

16. A building block or a slab per item 15, differing by using several containers, where at least two of them are connected to each other in parallel or in series.

17. A building block or a slab per item 15 or 16, differing by having a system to shut off channels of junction pipes or flanges either mechanically or by introducing a self-hardener, preferably from a tank with such a self-hardener, while the shutoff system may be controlled remotely.

18. A building block or a slab per any item 15-18, differing by having sulfur concrete or polymer concrete used for the whole body or one of its layers.
